(19) United States
(12) Patent Application Publication
(10) Pub. No.: US 2004/0015699 A1
(43) Pub. Date: Jan. 22, 2004

(54) Identification and contact information

(76) Inventors: Christopher Field Thomas, Victoria (AU); Steven Michael Giddings, Victoria (AU); Ellis Brover, Victoria (AU); Richard Gilbert Crothers, Victoria (AU)

Correspondence Address: LADAS & PARRY, 26 WEST 61ST STREET, NEW YORK, NY, 10023, US

(21) Appl. No.: 10/381,245

(22) PCT Filed: Sep. 24, 2001
(86) PCT No.: PCT/AU01/01194

(30) Foreign Application Priority Data
Sep. 22, 2000 (AU) PR0303
Nov. 15, 2000 (AU) PR1489

(51) Int. Cl. H04L 9/00

(52) U.S. Cl. 713/179

(57) ABSTRACT

Identification and contact information is captured and verified for dissemination. Electronic scals that identify an originator or author of an electronic message or document are inserted in the message or document. The seal forms an identification card for the originator or author based upon the verified contact information. A recipient or viewer of the message or document can view, in the message or document, the embedded seal that comprises a graphic and associated text. A network hyperlink reference from the seal to a server displays a seal verification page. The seal verification page comprises contact information for the originator or author, and other details such as those relating specifically to the message or document. The verified contact information is also used to provide a secure directory of contact information and a facility for printing business cards.

### FIELD OF THE INVENTION

The present invention relates to identification and contact information and relates particularly, though not exclusively, to identifying senders of digital communications and obtaining, verifying and distributing contact information.

### BACKGROUND

Company officials, government officers and individual citizens routinely use various types of physical identification to provide confirmation of their credentials to others with whom they are communicating or interacting with.

This identification of company officials and government officers often takes the form of standard clothing or uniforms. More formally, identification takes the form of identify cards and badges that identify the individual, the organisation that he or she represents and the position that they hold in that company. Individuals often use a drivers licence or some other proof of identity to confirm their credentials

With the growth of electronic and digital communications, interaction between individuals is increasingly performed using electronic communications systems such as email, the Internet, computer networks and telephone systems. These systems allow individuals to interact with each other at a geographical distance but, by their very nature, prevent effective identification of individuals by concealing their appearance and their proof of identity. This, lack of effective identification, combined with the ease with which “online” identities can be falsified, has given rise to various security technologies such as voice and data encryption. These encryption systems, though technically effective, are typically complex and can be difficult to set up and use. This complexity can pose a significant barrier to their use.

The increasing use of electronic and digital communication systems also increases the need to access and manage contact information (that is, associated names, titles, contact telephone numbers and so on). As people live increasing mobile lives both personally and professionally, the burden of managing contact information is also increasing. To this end, managing contact information is an exercise that involves substantial effort from individuals, businesses and other enterprises that routinely communicate with a number of entities.

Contact information is currently managed with a vast variety of disparate techniques and systems, ranging from telephone directories, personal contact management software applications, corporate groupware, personal organisers, mobile telephones, and so on. The use of these various tools often proves quite advantageous, but there are invariably difficulties arising from use of such tools.

Despite the substantial resources devoted to addressing problems associated with managing contact information, existing solutions fail to fully meet the needs of their users.

Email has essentially become a ubiquitous means of communication for people in both their personal and professional lives. Email has enhanced the ability with which contact information is shared between people.

In view of the above observations, a need clearly exists for improved identification technologies and techniques for dealing with contact information, especially business contact information.

### SUMMARY

Providing effective identification and managing the flow of identification and contact information (hereafter referred to as contact information) is desirably facilitated with the assistance of an entity able to co-ordinate the capture, dissemination and verification of that contact information. A recognition is made that appropriately accredited contact information enables the efficient and effective use of that information in a variety of contexts.

Contact information can be captured by interfacing with existing business processes, such as payroll-related functions and business card ordering processes, to allow for accurate recordal and verification of contact information. Contact information and can also be captured using processes specifically designed for this task.

In particular, contact information, once gathered and appropriately accredited, can be used as the basis for providing:

(i) electronic seals or “identity cards” for identifying the author of an email or other electronic document,

(ii) a source of automatically maintained contact information available by subscription,

(iii) a directory of contact information that is automatically maintained,

(iv) business or personal cards that promote the source of contact information noted in (ii).

Essentially, accredited contact information can be provided from one or more, trusted and secure sources of contact information in a variety of contexts.

### DESCRIPTION OF THE DRAWINGS

FIG. 1 is a schematic representation of different services available using the described techniques involving accredited contact information.

FIG. 2 is a schematic representation of various components involved in the Internet-based distribution of contact information as described herein.

FIG. 3 is a flowchart that represents the process of obtaining accredited contact information.

FIG. 4 is a schematic representation of various components involved in generating, sending and receiving a seal.

FIG. 5 a flowchart that represents the process of sending a recipient a message or document having an electronic seal that verifies accredited contact information.

FIG. 6 is a flowchart that represents the process of a recipient verifying the accredited contact information associated with an electronic seal.

FIG. 7 is a schematic email message containing a seal.

FIG. 8 is a schematic screen view of seal information provided by a server for viewing by a recipient of the email message of FIG. 7.

FIG. 9 is a flowchart of the process involved in providing a directory of accredited contact information.

FIG. 10 is a flowchart of the process involved in providing business cards generated based on accredited contact information.

FIG. 11 is a schematic representation of a computer system suitable for performing the techniques and providing arrangements described with reference to FIGS. 1 to 10.

### DETAILED DESCRIPTION

Techniques for using contact information are described herein in relation to various applications. These applications include:

generating and applying electronic seals to documents or messages

confirming the authenticity of the electronic seals to recipients

providing a source of automatically maintained accredited contact information using the accredited contact information

providing an electronic directory using the accredited contact information

printing business cards using the accredited contact information

Applications of the described techniques are based upon an initial and ongoing process of accrediting contact information. These applications can also be based upon non-accredited contact information, not withstanding perceptions that the utility of a service based on non-accredited contact information is less than that of a service based on accredited contact information.

These applications are presented herein as distinct services that are referred to as follows:

seal service

contact management service

print service

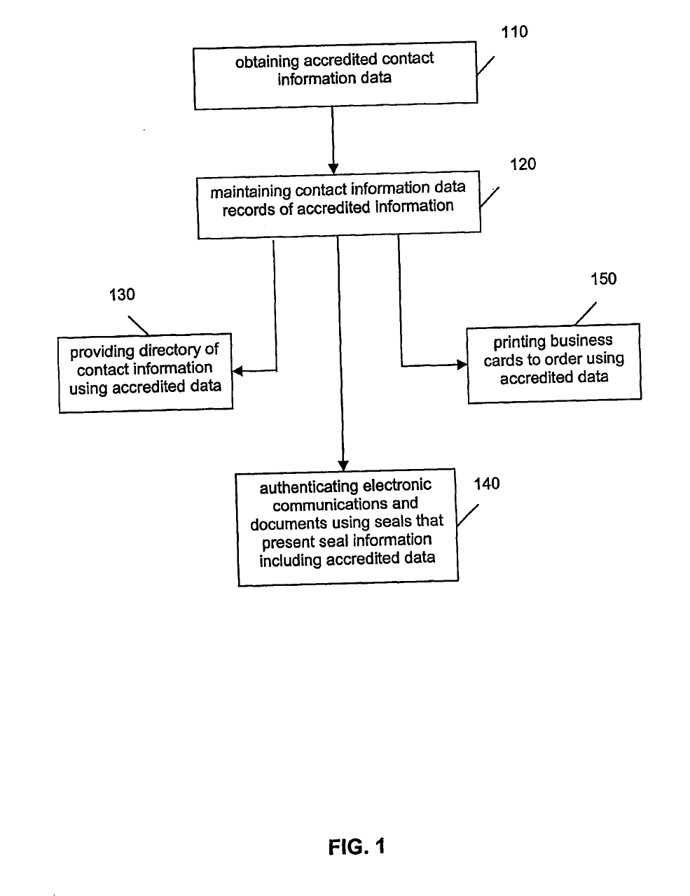

FIG. 1 schematically represents these different services. Accredited contact information is obtained in step 110, and maintained in records in step 120. A directory of the recorded information is provided in step 130 (contact management service). The recorded information is used as a basis for authenticating documents or messages using seals in step 140 (seal service). Business cards can be printed based on the recorded contact information is step 150 (print service).

Each of the aspects/services mentioned above are described in turn below.

Accredited Information

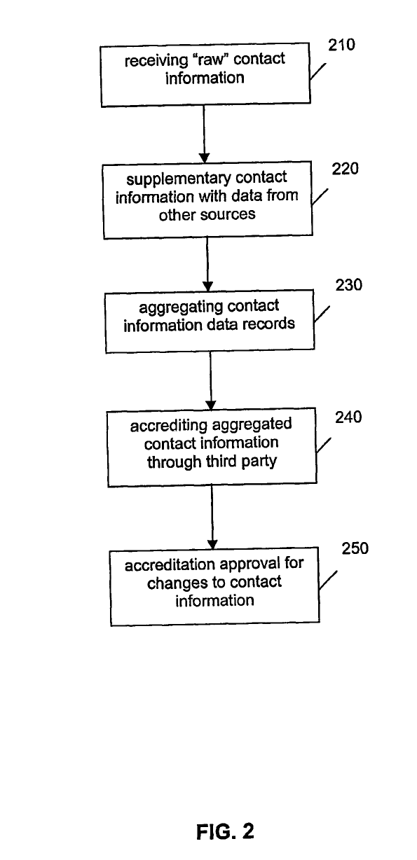

FIG. 2 is a flowchart that represents the accreditation of contact information. In step 1, “raw” contact information is provided by collecting information directly from individuals or by interfacing with existing databases. Existing databases of various kinds can provide contact information for different people. In particular, telephone and other contact directories are generated from databases that are sources of contact information. In a business context, payroll databases and human resource management databases typically provide contact information for employees.

In step 220, “raw” contact information is supplemented with data from other sources. This supplementary information is supplied if the initial contact information is inadequate or incomplete. Contact information data records from different sources can be aggregated in step 230 to provide a record of contact information.

Aggregated contact information is accredited in step 240. This can involve various different processes, but the objective is in all cases the same: to verify the correctness of the recorded contact information.

As part of a maintenance process, accredited contact information is updated when necessary in step 250.

Raw contact information can be obtained directly from individuals or through an interface with an appropriate database that stores the details of an organisation's employees. The initial data could be as simple as an individual's name. This data can be supplemented through the provision of a process that allows individuals to enter their additional data such as telephone number and address. Preferably there is an approval loop, so that data becomes accredited once the data is “certified” by a designated authority within the organisation, or a suitable third party.

Communications Infrastructure

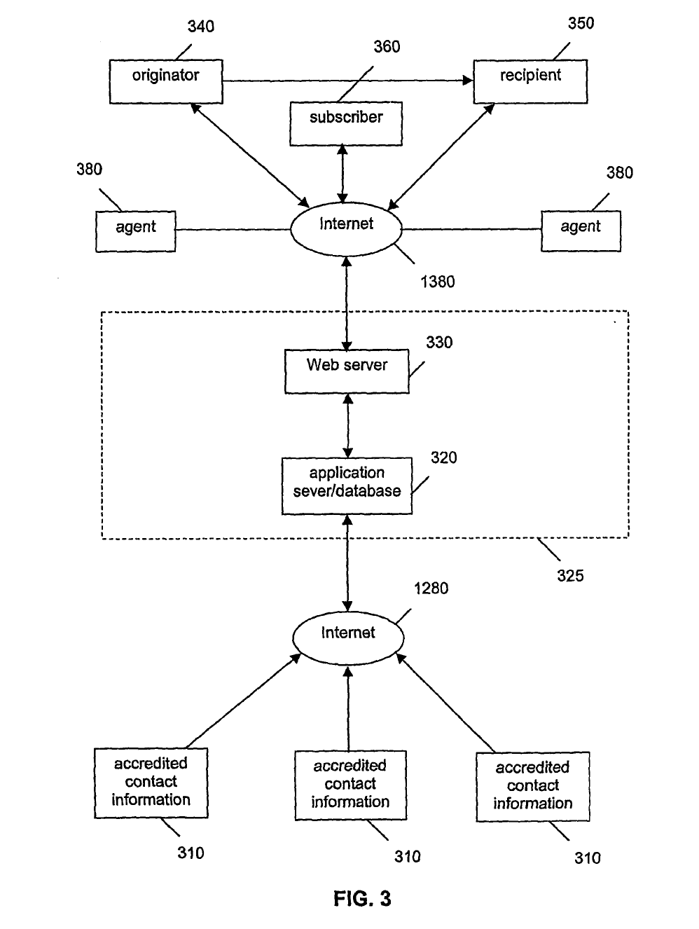

FIG. 3 schematically represents components of a system for providing the services described above. Accredited contact information 310 is provided, via the Internet 1180 to an application server database 320. The application server 320 and Web server 330 on computer system 325 can be accessed using the Internet 1180 by various entities, namely originator 340, recipient 350, subscriber 360 or agent 380.

Though implementations are described herein with reference to the Internet 1180, a variety of implementations can use alternative communications means such as virtual private networks, local-area and wide-area networks, and cellular or other wireless networks.

With reference to the seal service, a message originator 340 communicates to a message recipient 350. Both originator 340 and recipient 350 communicate with the server 325. With reference to the contact management and print services, subscribers 360 and agents 380 communicate with the server 325 through the Internet 1180.

Electronic Seals

A first aspect of the described techniques is a seal service that provides electronic seals or “identity cards” for identifying the author of an email or other electronic document. The seal service is designed to assure a recipient of a message or document of the identity of the sender or author of the message or document. In a business context, a measure of protection is provided against misrepresentation or fraudulent use of communication channels by company employees. In respect of these observations, the seal service allows users to:

“sign” electronic correspondence

verify the source of electronic correspondence

verify the identity and authority levels of an individual signing a document on behalf of a company

determine if an email message, or other electronic correspondence, has been opened

identify the time and date that an email message, or other electronic correspondence, is accessed and the network location from which the message is accessed on each occasion that the message is accessed.

In the implementation described herein, the term “signing” is not used in the context of digital signatures involving digital certificates relying on public key infrastructure. However, the described implementations can be modified to use public key infrastructure and digital certificates if required.

A user can “sign” an electronic document by obtaining a dynamically generated identification seal from an application server (for example, via a World Wide Web Internet site) from which the seal service is provided.

The electronic identification seal is inserted into or attached to the electronic communication or document by the relevant user. Upon receiving the electronic communication, the recipient is able to assess whether the source of the communication or document is legitimate by interrogating the seal.

The seal provides a hypertext link to the application server referred to above, which displays information about the sender, and the time and date of issue of the seal. Other information may also be displayed or provided, such as a description of the electronic communication or document, and the responsibility or authority of the sender.

The seal also includes a hypertext reference to an image stored on the application server. In most email clients or viewers, this image is obtained from the server for “inline” viewing by the recipient. At the application server, a record is made of each such access. For example, for each seal, a log records the time of access for the seal graphic, and the network address (for example, IP address) from which the request originated. The seal graphic can be modified between successive accesses to reflect information recorded in the log.

For example, if the image has already been accessed, a different coloured seal image can be displayed accompanied by a text message. The message might be, for example, “this email has already been read”. Maintaining a log of this nature provides an audit trail of where an email has travelled, who has accessed the message and at what time the message was accessed. Further, information reflected in the log can be forwarded to the agent responsible for sending the message to the recipient. For example, the agent can be notified when the seal image is first accessed, indicating that the electronic communication has been read.

Any inconsistency between the information provided by the seal and the information indicated in the electronic communication or document alerts the recipient to an actual or potential misrepresentation on the part of the sender.

Optionally, seals expire after a predetermined period selected by the user. Preferably, the application server prevents reuse of a seal, and the user who originally generated the seal is notified if any attempt to reuse the seal occurs.

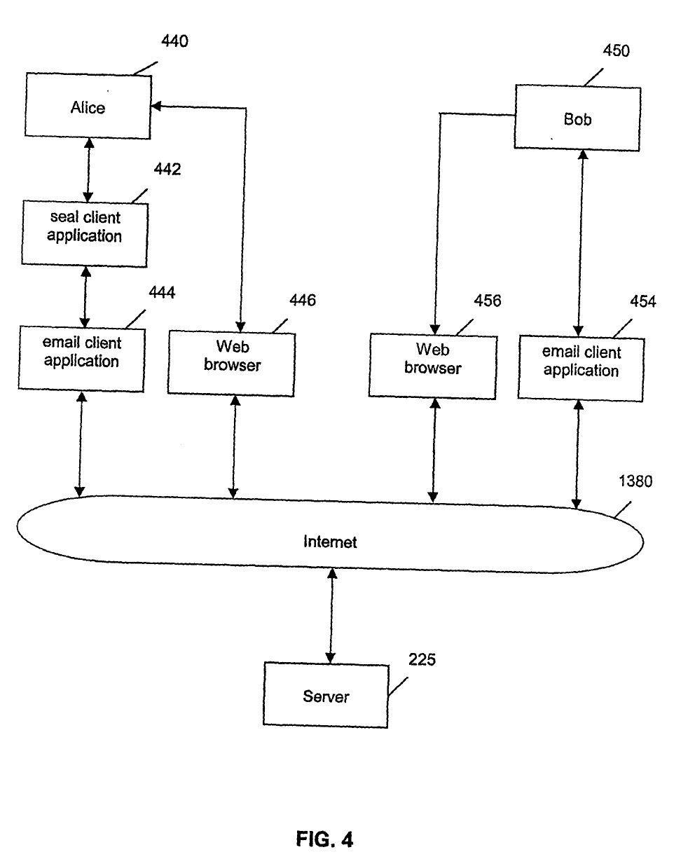

FIG. 4 schematically represents the relationship between various components involved in the process of generating, sending and verifying seals.

An originator 440 (Alice) uses a seal client application 442 and a Web browser 446. The seal client application 442 interacts with an email client application 444. The email client application 444 and the Web browser 446 both communicate via the Internet 1180 with the server 225. Similarly, a recipient 450 (Bob) uses an email client application 454 and a Web browser 456. Both the email client application 454 and the Web browser 456 are connected to the Internet 1180, to which the server 225 is also connected as noted above. In an alternative implementation, the seal management software can be fully integrated into a third-party software application, such as an email client or word processing application, or can be fully integrated into a computer operating system.

Alice 440 can send Bob 450 an email message via the Internet 1180. Alice 440 and Bob send and receive the email message using their respective applications. The seal client application 442 and the Web browsers 446 and 456 are specifically involved in generating and verifying the seal 930, as described below.

The process of inserting a seal into a document is controlled by software written or configured to enable interaction between the seal server and document authoring software that results In a seal being insert into, or attached to, a document.

In one implementation, the software takes the form of an independent client application 442. In an alternative implementation the client software is integrated into the document authoring software, in a third implementation the client software is integrated into the computer operating system and in a forth implementation the client software is resident on a server and is controlled through a web browser.

The software may be installed on an individual personal computer, workstation or other computerised communications device or it may be installed on a network server and controlled from an individual personal computer, workstation or other computerised communications device

To insert a seal in an individual document, a registered user launches the software to view and interact with a user interface that can be used to control the process of seal insertion.

Once the client software 442 is running, the originator 440 (Alice) submits her accreditation details, such as username and password. Alice 440 can then use the user interface to enter any additional information for this seal. This additional information might be, for example, a description of the document into which the seal is being inserted. Alice 440 then instructs the software to create a seal. This invokes a software routine that causes the server to create a new seal. The seal data is transferred to the client software and the client software interacts with the document authoring software and inserts the seal into the document.

Alternatively, an originator 440 can be authenticated through the process of logging onto their company network. Consequently, the originator can use their email client software application as they usually would. When a new email message is generated, a seal is automatically inserted into the message.

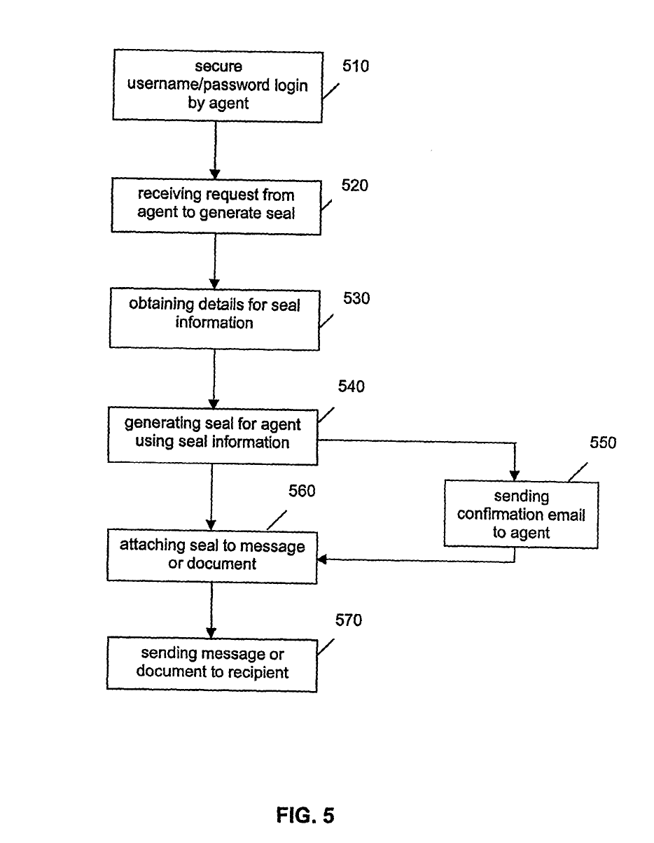

FIG. 5 is a flowchart that represents the steps involved in generating and sending a seal. In step 510, a user logs in using a username and password combination or identifies themself using some other software or hardware authentication process. Once the user is duly identified, the server receives a request from the user to generate a seal in step 520. Details for the proposed seal of obtained in step 530. In step 540, the seal is actually generated on the basis of this information obtained in step 530.

A confirmation email can be sent to the recorded email address of the user in step 550. This is a security measure that can be optionally adopted if considered appropriate. In step 560, the seal is attached to the message or document with which the seal is intended to be used. The message or document is then sent to the recipient as intended in step 570.

User Registration

Before an individual can use any of the described services, the individual must submit registration details, such as name, contact details, job title, authority level, and have those registration details independently certified. An individual can have more than one set of details recorded for different uses. For example, an individual may have a “business profile” and a “personal profile”.

Typically the information is entered into a form on a Web site. This information is transferred into a database and marked with a status of “uncertified”. The information is then checked using a certification procedure. Once the information has been confirmed as being correct its status is changed to “certified” by, for example, an authorised company officer. The user is then formally registered and is allocated a unique identifier such as a username and password. This information is stored in a database.

The certification procedure is typically managed using the Internet or other network-based technology and can be implemented using a standard database (such as Oracle databases), web servers (such as Apache), and web application server.

Generating Seals

An originator (such as Alice) identifies themself with the application server using a username and password combination. The username can be, for example, the serial number assigned to that originator as described above. Any other suitable type of authentication can also be used.

The originator enters a text description of the communication or document in association with which the electronic seal is to be generated. When the details are complete, a seal is generated for use by the originator. Optionally, as a security measure, a confirmation message (for example, via email) may be sent to the registered email address of the originator.

The seal can be used by the originator in connection with an electronic communication such as an email message sent to a recipient. When the recipient receives the email carrying the seal on their computing device, the seal can be interrogated, and refers to the application server for information concerning the seal. The application server is able to then supply to the recipient information concerning:

the contact information of the originator (including, for example, at least their name and who for they work )

the time and date at which the seal was generated

the text description of the email provided by the originator

Other types of information can be associated with the seal. For example, it may be desirable to include information specifying the authority of an employee originator within their organisation. For example, this may include information specifying the types of decisions that they can authorise.

Further, the originator may submit the document to the application server so that the application server can derive statistical document information from the document. This document information can be included in the seal information. The recipient may then independently submit the received document, generate corresponding document information which can be compared with that provided by the seal.

Registered users can “sign” mail messages and electronic documents with their seal using a client software application as follows.

The user launches the client software on their computer system, personal digital assistant (PDA), mobile telephone or other network-connected computer device.

The user performs an authentication process to establish the user's credentials. Typically this process involves the entry of a username and password combination. The user enters any other information that the user wishes to be linked to the seal into the client application. Server-side processes are initiated by appropriately interacting with the client software user interface.

The server receives this information submitted by the user through the client application. The server then checks for a matching record in the database. If a match is not found, the server returns a predetermined message to the client application, which Is displayed to the user via the client software user interface.

If a match Is found in the database, the server application creates:

1. A unique database record for the seal.

2. A unique seal identifier (this identifier is typically an alphanumeric text string that is entered in the database record).

3. Seal images for each of the status levels that apply to that seal that is entered in the database record noted in item 1.

4. A database entry recording the initial status of the seal in accordance with predetermined parameters.

5. A network or Internet location incorporating a reference to a unique network or Internet location that enables the server to return the appropriate seal image. This is typically a unique hypertext reference to a seal image stored on the server.

6. A reference to a unique network or Internet location that enables the server to display the seal verification page that includes contact information recorded for the user. Typically this data is displayed in a Web browser, but can also be displayed by the client application or by third party software such as contact management applications.

The server sends a response to the client application that contains the Internet or network locations for the image (item 5) and the seal verification page (item 6).

The client application inserts these responses into the document that is created by a host application, such as a HTML-compatible email client application, along with various programming tags that the host application requires to display the seal image and the hypertext link. Typically these tags are HTML tags but could be another type of programming tags.

The seal Insertion process may be initiated by a registered user for each individual document. Alternatively, software can be configured so that seals are automatically inserted each time a document is created, or each time a document is sent.

Optionally, as an additional security measure, information passed between the client software and the server software can be coded or encrypted to prevent unauthorised individuals reading or using the information in an inappropriate or malicious manner.

Verifying Seals

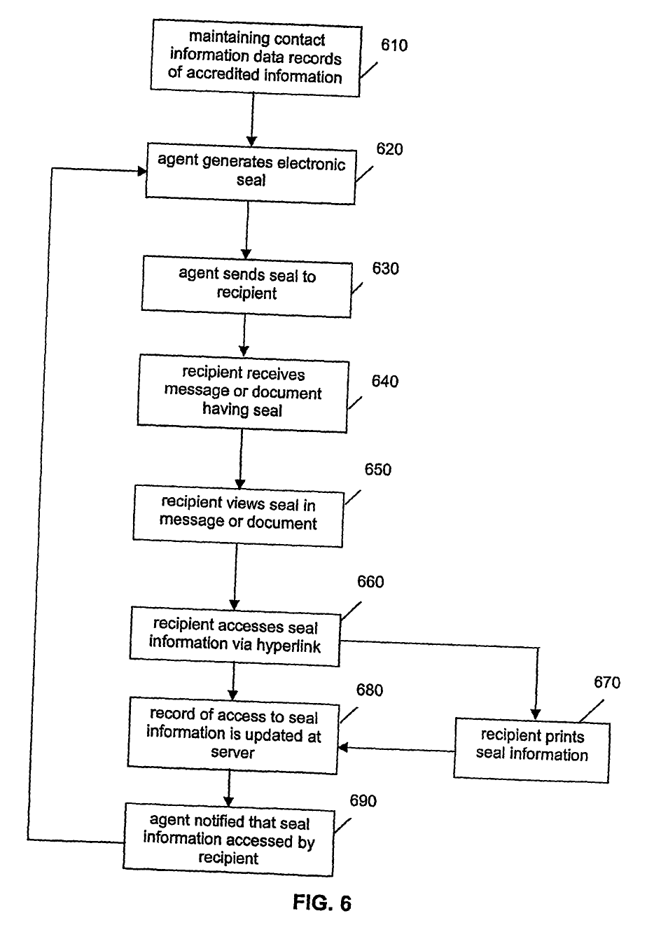

FIG. 6 is a flowchart at steps that occur in generating, sending, receiving and verifying a seal. In step 610, contact information is maintained. An agent generates a seal in step 620, and sends the seal to a recipient in a message or document in step 630. The recipient receives the relevant message or document in step 640, and views the seal in step 650.

The recipient accesses seal information by activating a hyperlink associated with the seal, in step 660. The recipient can optionally print this seal information in step 670. In response to access by the recipient in step 660, records are appropriately updated in step 680. Further, the agent can be optionally notified that the seal information has been accessed by the recipient in step 690. As indicated, the agent can generate further seals in step 620.

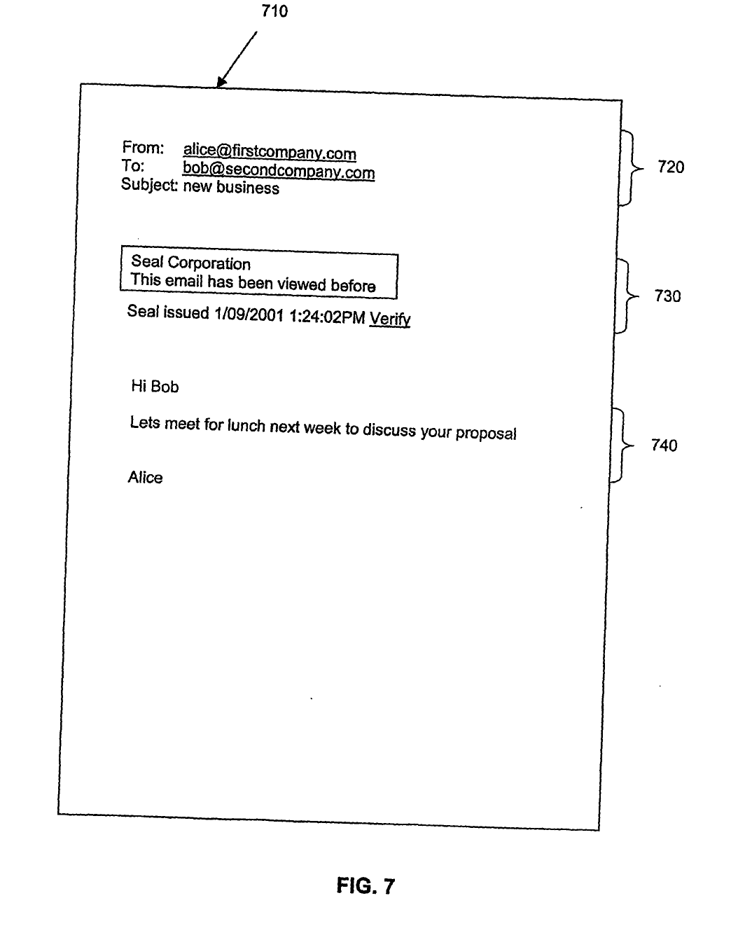

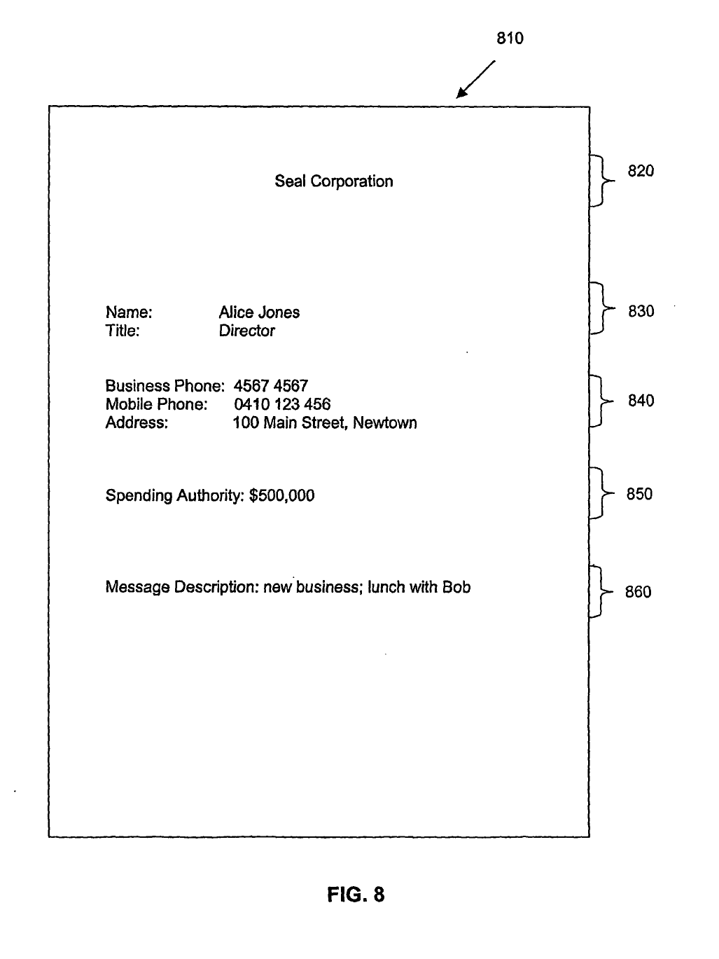

FIGS. 7 and 8 are respective schematic screen shots of an email message received by Bob from Alice, and the Web page to which the seal links in the email message from Alice to Bob.

FIG. 7 represents an email message 710 that is received by Bob from Alice. When Bob receives this message, he notes that it contains header information 720 that sets out the originator (Alice), the recipient (Bob) and the subject of the message (new business).

Bob also notes that the email 710 contains an embedded seal 730 and related seal information. The seal comprises a rectangular graphic element displayed in the email 710 below the header information 720. The seal graphic indicates that the seal is provided by “Seal Corporation” and that “this email message has been viewed before”. The seal also comprises some additional text that indicates when the seal was generated. The seal graphic provides a hypertext link to the server. The text also provides the same hypertext link to the server, indicated by the underlined word “Verify”.

Optionally, the hypertext link can be “mapped” to the seal image, so that the hyperlink associated with the seal image is not visible within the email client, even though the seal image behaves as the hyperlink. When a seal is inserted into a document that does not support graphical elements, the seal can be represented as plain text with a link to the server.

The email 710 from Alice contains a message body 740 in which Alice expresses that she wishes to lunch with Bob shortly to discuss his new proposal.

When the recipient (Bob) opens an email message or document that incorporates a seal, in a HTML-compatible email client application or other application, the application resolves the programming tags and accesses the linked Internet or network locations. When the Internet or network location is accessed the server

reads the seal status setting from the database record

returns the seal Image that corresponds to the status setting

records the date & time that the internet or network location was accessed in the database record

records the network address, such as the IP address, and/or domain name of the originating client

alters the status setting In the database record to the next status if required

The recipient can then observe the seal image and the hypertext link. Each time the document is accessed from a network connected computer or computerised device the status is updated and the corresponding seal image are displayed. This process imparts a dynamic nature to the seal and ensures that it can change each time that it is viewed.

This dynamic behaviour can be used to provide a visual indication to the viewer that the seal has not been previously viewed, that the document has been previously opened or that the document has been forwarded from another IP address. The seal can also be used to drive a counter showing how many times the seal has been accessed or display any other sequence of images or information.

FIG. 8 schematically represents a seal verification page 810 associated with the seal 730 depicted in FIG. 7. When Bob opens the email message 810 that incorporates the seal 730, Bob is presented with a hyperlink that can be used to display the seal verification page recorded on the server. The seal verification page displays contact details and other information associated with that particular seal 930. This information is typically displayed in a web browser but may also be displayed In other types of applications.

The seal verification page 810 displays:

the nam of the company that provides the seal (Seal Corporation), and any related details 820

the originator's name and title (Alice, directory) 830

the originator's telephone numbers and address 840

other information about the originator (spending authority of $500,000) 850

message-specific Information (new business; lunch with Bob) 860

any other piece of relevant identification and contact information.

Tracking Seal Access

The server creates a database entry each time a seal is accessed. Accordingly, a registered user can access a record of each seal that the server has issued using authentication credentials.

These record includes: seal number, seal issue date, seal issue time, and, for each access of that seal, the seal access time, seal status (at time of seal access), and network address of the accessing computer.

Access to this information is provided using the client application as follows:

1. The registered user submits his authentication credentials to the server using either the client application or a Web browser form provided by the server.

2. The server searches for a matching user and if found returns information on all seals issued to that user.

3. This information is then displayed and may be sorted and organised for analysis.

Secure Directory

The second aspect of the contact information service is a contact management service that allows for the controlled sharing of contact information between different parties.

The contact management service aims to allow for the:

distribution of accurate and up to date of information for an individuals or company's employee contact information to third parties

retention of an individual's or employee's contact information for external business contacts when that employee resigns or is transferred to a different role

removal of the need to separately enter and maintain contact information in mobile telephone memories or other devices that electronically communicate data

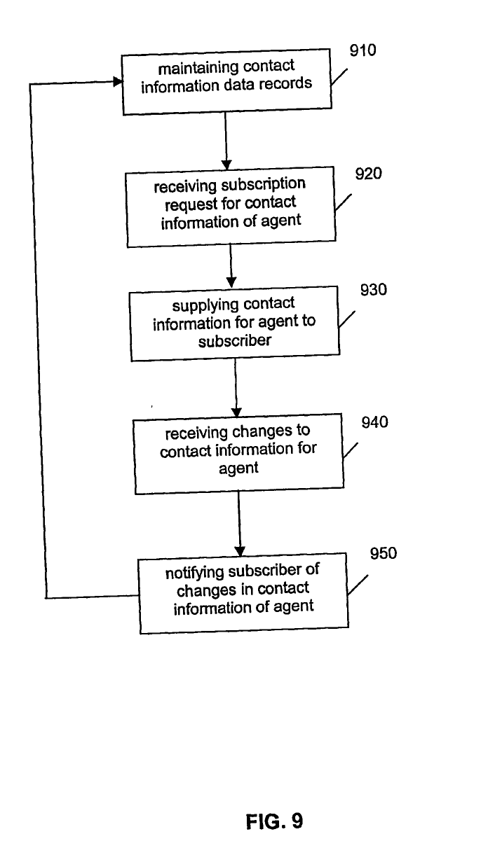

FIG. 9 represents steps involved in providing the contact management service. In step 910, accredited contact information is appropriately recorded and maintained. A subscription request is received in step 920, and that information is supplied in step 930.

Changes in the contact information are received in step 940.

Subscribers to relevant contact information that changes are notified in step 950. Records of contact information are maintained in step 910 with any such changes.

Registered clients of the contact information service can use the contact management service to selectively “publish” employee contact information. Any party can, in accordance with the permission granted by the relevant “publisher”, subscribe to the published contact information. Such contact information can be electronically transferred to designated contact management software, and automatically updated as required. For example, when the contact information changes it can be automatically updated, or it may be automatically updated after a predetermined time interval.

Alternatively, users of mobile phones, PDAs and other electronic devices that have an electronic data connection can access the data on the server as if the data resides in the electronic address book of electronic device.

To become a subscriber, the subscriber can register their own contact information (for example, name, email address, title, address, telephone number, fax number etc). This assists in notifying the subscriber of changes in contact information for which they subscribe. The subscriber is also provided with the opportunity of becoming a publisher, though the submitted contact information is not accredited at this stage. Preferably, though, a verification process can be offered so that data submitted by a subscriber can be given accredited status, allowing full use of the contact management and seal services.

As mentioned below, business cards printed with the assistance of the print service may carry a designated logo indicating that the cards were in fact printed using the print service. This is permissible where client organisations publish the contact details of their agents using the contact management service. This communicates to third parties to whom the business cards are presented that the contact information is published, and is available in accordance with the facilities offered with the contact management service. Employees who carry business cards with this designated logo have the opportunity to explain the nature of the benefits available to third parties taking advantage of the contact management service in relation to, for example, obtaining the contact information electronically. Of course, the contact management service is still available to subscribers even if there are no indications on the cards. An employee may elect to instead include their number on separate physical or electronic correspondence, for example, as part of a signature on an email message.

When an employee leaves a particular role, external third parties formerly in contact with that employee often have difficulty in determining who they should be contacting in future. In many cases, interaction ceases, leading to a loss of continuity, business opportunities and revenue. One feature of the contact management service is the option of being able to contact subscribers to a particular employee's contact information to offer them the opportunity to:

modify the existing contact information to reflect new details; or

substitute the existing contact information with that of his or her replacement

In addition, this information also provides the opportunity for the company to transmit electronic communications, such as emails, to these individuals advising them of company changes or opportunities such as special promotions.

To use the contact management service, a company or an individual provides a source of authenticated employee contact information. As discussed, this information is preferably captured by interfacing with an existing process used by the client company. This may include, for example, processes used in relation to managing the payroll system, processes used for ordering business cards or processes designed specifically for the capture of the contact data. Data can also be captured by submitting information that is subsequently verified by manually accredited third-party agents.

Each time data is re-approved, the data Is updated in the certified contact information database used for providing the contact management service. In turn, this information is made available to subscribers.

Employees whose contact information Is published using the contact management service are preferably issued a respective unique identifier that can be optionally printed on business cards, or included in electronic communications or documents, or otherwise provided to third parties. This unique identifier can be used by third parties to access the contact information relating to that particular employee. Third party access to contact information can also be enabled using an identifier derived from the contact information itself. The identifier could be as simple as an email address in an email which may or may not have a characteristic which signifies that the relevant contact details are available from a third party. The publisher is preferably able to control the way in which third parties can subscribe to his information. Accordingly, when contact information is published, the publisher can determine different options by which third parties subscribe to that contact information. For example, publishers can be provided with the ability to “screen out” subscription requests as required. It is preferred that a publisher is able to elect whether his contact information is:

(a) not accessible by third party subscribers

(b) can be accessed using an assigned unique identifier (for example, serial number) only

(c) can be freely accessed using either an assigned unique identifier, or identifier such as an email address.

In some cases, various parties share a common email address. In cases such as this, a subscriber is required to specify an email address, and a further piece of contact information (for example, surname) so that the subscriber uniquely identifies the relevant publisher.

The contact management service is preferably used in conjunction with a client-side software application that operates on subscriber's client computing devices. This client software application functions as an intermediary between the application server and the subscriber's contact management tools such as contact management software applications operating on the client computing device.

To access contact information for a particular employee, a subscriber enters the publisher's serial number in the client application. Alternatively, depending on the options used by the publisher, the subscriber may enter one or more other items of identifying Information to similarly access the same contact information. For example, subscribers may be able to enter a publisher's email address to access that publisher's contact information. Preferably, though, only one piece of information is required to access the contact information as a subscriber.

Once data is accessed in this way the server records what names have been downloaded by the user and retains this information such that the user can at any time access their personal address book. This can be performed using an electronically connected device such as a mobile phone or PDA, or else by using a browser on the Internet.

Each time a particular subscriber's contact information is updated, subscribers to that user's contact information are notified accordingly, and/or the relevant contact information is updated on the subscriber's computing device via the client application, which interacts with the application server.

Subscribers are presented with the option of creating a new record in their various contact management applications, or replacing the existing contact information with the revised contact information as required.

The client application can synchronise contact information records between applications and devices. The most recent contact information record, maintained in, for example, an email client application, can be uploaded to a personal digital assistant, using the client application.

Similarly, subscribers can send contact information, or an appropriate subset thereof to a mobile phone or other similar device. The client application is able to interact with the relevant telecommunications carrier's infrastructure, via the Internet, to make the subscribers contact information records available via the cellular mobile telephone (for example, GSM) network.

As an example, an employee (or “publisher”) may write to a third party (or “subscriber”), or provide a business card, send an email or otherwise contact that person. The publisher is able to determine how their contact information is shared with subscribers. The subscriber is able to initiate a subscription for the publisher's contact details by reference to their serial number, or one or more different pieces of contact information relating to that publisher. The client application controls any updates to the publisher's contact details on the subscribers computing device. Similarly, the contact information can be synchronised on a variety of other devices, such as laptop computers, personal digital assistants etc. Contact information relating to publishers Is also provided to the telecommunications carrier's cellular networks to allow subscribers to synchronise contact information with their mobile telephones, or other device able to use the cellular network. Contact information relating to publishers can also be provided to subscribers via a Web page that may be viewed with any suitable Web browser.

Business Cards

A third aspect of the described techniques is a print service that provides a business card procurement solution. The service is offered to client organisations (typically companies) that need to register to use the service to obtain business cards for their agents (typically employees). Registration typically requires that the company appoint one or more business card administrators.

The print service allows companies to:

to control business card design and format

to delegate the data entry process to the respective employees requiring the business cards

use a centralised online control and authorisation process to obtain business cards for employees

print a visual identifier on business cards indicating that the contact information on the card can be obtained in digital format for automated entry into a contact management application and, subsequently, automatic updating when the data is changed

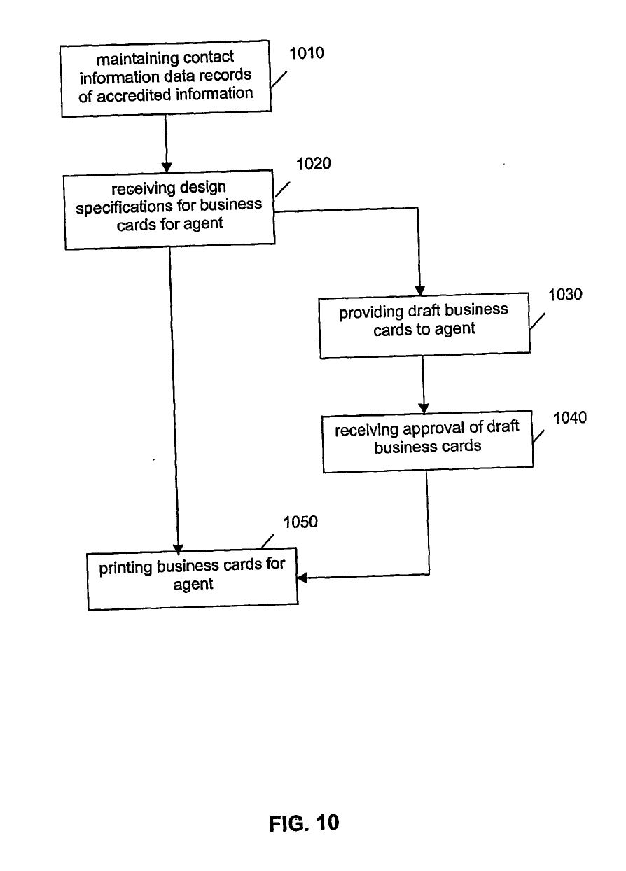

FIG. 10 represents steps involved In providing the print service. In step 1010, accredited contact information is appropriately recorded and maintained. Design specifications for the business cards are received In step 1020. At this stage, a proof is typically provided to employees in step 1030 for their approval in step 1040. Once the card design is approved, the cards are actually printed in step 1050. In some cases, such as reordering business cards, the cards are reprinted in step 1050, immediately after the design specification is received in step 1020.

The design and format specifications of the business cards may be determined by the client organisation, or outsourced to a third party designer, with the design and format being ultimately approved by the organisation.

The application server receives this information, as well as requests for business cards from agents or employees of the organisation. The application server is able, using the design and format specifications, to generate a digital proof of the proposed business card for the employee.

When the proof is approved by the relevant employee, and the contact information approved by the business card administrator for the organisation, production commences and the employees are appraised of production status. The necessary details required to produce the business cards are forwarded to production facilities for production as indicated.

Bulk ordering discounts are available to organisations and the administrator can consolidate approved but unordered business card orders from employees to obtain these discounts.

Business cards printed in accordance with the print service may be authorised to be printed with the addition of a designated logo or identifier indicating that the cards are associated with the seal and more particularly the contact management service described above. A person who has received the business card can subscribe to the contact information using the contact management service to ensure that the contact information they have for the relevant employee is current, and can be accessed if the business card is misplaced.

Computer Hardware and Software

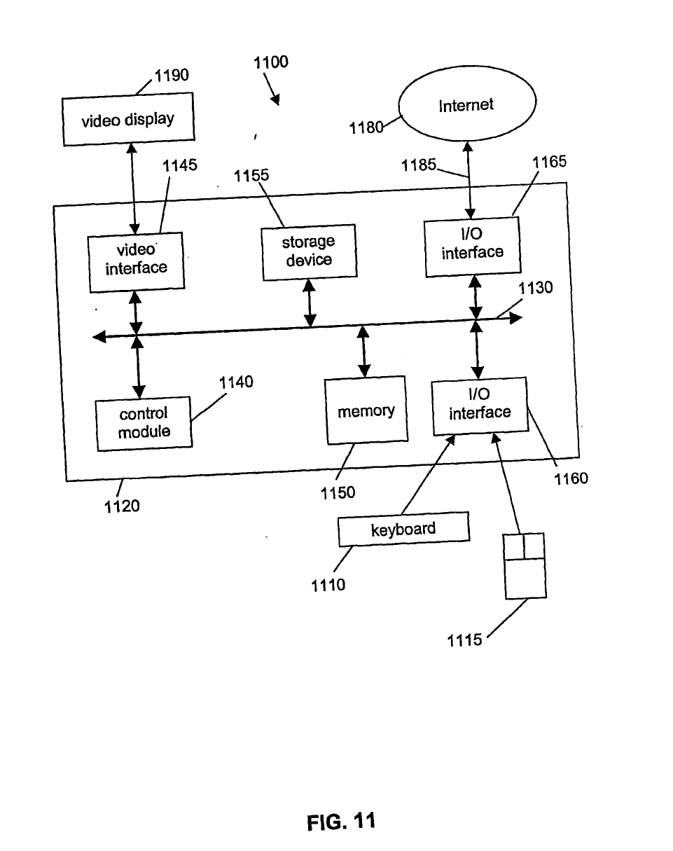

FIG. 11 is a schematic representation of a computer system 1100 that can be used to perform steps in a process that implement the techniques described herein.

The computer system 1100 is provided for executing computer software that is programm d to assist In performing the described techniques. This computer software executes under a suitable operating system installed on the computer system 1100.

The computer software Involves a set of programmed logic instructions that are able to be interpreted by the computer system 1100 for instructing the computer system 1100 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means, that perform particular steps in the process of the described techniques.

The components of the computer system 1100 include: a computer 1120, input devices 1110, 1115 and video display 1170. The computer 1120 includes: processor 1140, memory module 1150, input/output (I/O) interfaces 1160, 1165, video interface 1145, and storage device 1155.

The processor 1140 is a central processing unit (CPU) that executes the operating system and the computer software executing under the operating system. The memory module 1150 includes random access memory (RAM) and read-only memory (ROM), and is used under direction of the processor 1140.

The video interface 1145 is connected to video display 1190 and provides video signals for display on the video display 1170. User input to operate the computer 1130 is provided from input devices 1110, 1115 consisting of keyboard 1110 and mouse 1115. The storage device 1155 can include a disk drive or any other suitable non-volatile storage medium.

Each of the components of the computer 1120 is connected to a bus 1130 that includes data, address, and control buses, to allow these components to communicate with each other via the bus 1130.

The computer system 1100 can be connected to one or more other similar computers via a Input/output (I/O) interface 1165 using a communication channel 1185 to a network 1180, represented as the Internet.

The computer software program may be provided as a computer program product, and recorded on a portable storage medium. In this case, the computer software program is accessed by the computer system 1100 from the storage device 1162. Alternatively, the computer software can be accessed directly from the network 1180 by the computer 1120. In either case, a user can interact with the computer system 1100 using the keyboard 1110 and mouse 1115 to operate the programmed computer software executing on the computer 1120.

The computer system 1100 is described for illustrative purposes: other configurations or types of computer systems can be equally well used to implement the described techniques. The foregoing is only an example of a particular type of computer system suitable for implementing the described techniques.

Conclusion

A method, a computer system and computer software are described herein in relation to disseminating accredited contact information via a number of channels.

In the foregoing, described Implementations can be used to provide a process to facilitate the dissemination and exchange of contact information, through services such as the authentication of electronic communications and documents.

Various alterations and modifications can be made to the implemented techniques and arrangements described herein, as would be apparent to one skilled in the relevant art.

1. A method for permitting a recipient of an electronic communication or document to assess the origin or other details of that communication or document, the method comprising the steps of:
maintaining a plurality of records of information relating to a plurality of respective agents;
allowing an agent to generate an electronic seal for use in connection with an electronic communication or document to be sent by said agent to a recipient; and
displaying or providing, to said recipient, seal information associated with said electronic seal;
wherein said seal information includes said agent information, and can be used by said recipient to assess the legitimacy of said electronic communication or document in connection with which said electronic seal is used.

2. The method as claimed in claim 1, wherein said electronic seal includes a hypertext reference which can be referenced on a secure server by said recipient to access said seal information relating to said electronic seal.

3. The method as claimed in claim 1, wherein said seal information at least includes agent information.

4. The method as claimed in claim 3, wherein said agent information comprises one or more of: the name, title and company of the agent.

5. The method as claimed in claim 3, wherein said seal information further comprises the time and date at which the seal was generated.

6. The method as claimed in claim 3, wherein said seal information further comprises a description provided by the agent prior to generation of the seal which relates to the electronic communication or document in connection with which the seal is used.

7. The method as claimed in claim 3, wherein said seal information further comprises a description of the authority granted to the agent by the organisation.

8. The method as claimed in claim 1, wherein said electronic seal can be deemed unable to be used after a predetermined period of time to reduce the risk of the seal being used by unauthorised third parties.

9. The method as claimed in claim 8, wherein said predetermined period of time is selected by the agent responsible for generating the seal.

10. The method as claimed in claim 1, wherein the seal information is provided only once to a particular recipient.

11. The method as claimed in claim 1, further comprising the step of: notifying the agent that the seal has been generated.

12. The method as claimed in claim 1, further comprising the step of: notifying the agent when the seal information is accessed by the recipient.

13. The method as claimed in claim 1, wherein said electronic seal comprises a hypertext reference to a graphical object on a server, and said graphical object is displayed within said electronic communication after being accessed from said server, when the recipient accesses or views said electronic communication.

14. The method as claimed in claim 13, further comprising the step of: recording, at the server, a log of each access to said graphical object.

15. The method as claimed in claim 14, wherein the log records the time of the access and the network address from which the access originates.

16. A method for generating an electronic seal for use in connection with an electronic communication or document, the method comprising the steps of:
receiving from an agent a request to generate an electronic seal for use in connection with an electronic communication or document;
receiving from said agent a description of said electronic communication or document in connection with which said electronic seal is to be used; and
generating said electronic seal and providing said electronic seal to said agent for use in connection with said electronic communication or document;
wherein said electronic seal can be used in connection with said electronic communication or document provided by said agent to a recipient to allow said recipient to access seal information associated with said electronic seal.

17. A method of generating an electronic seal for use in connection with an electronic communication or document, the method including:
receiving from an agent an electronic document and a request to generate an electronic seal for use in connection with said document;
analyzing said electronic document to derive document information from said document in connection with which said electronic seal is to be used; and
generating said electronic seal and providing said electronic seal to said agent for use in connection with said electronic document; and
displaying or providing, to said recipient, seal information associated with said electronic seal;
wherein said seal information includes said document information, and can be used by said recipient to assess the legitimacy of said electronic document in connection with which said electronic seal is used.

18. The method as claimed in claim 17, further comprising the step of: inserting the electronic seal is inserted in the document.

19. The method as claimed in claim 18, further comprising the step of: receiving, from the recipient, said electronic document and independently generating said document information for comparison with the document information provided by the seal.

20. The method as claimed in claim 17, wherein the document information includes statistical information relating to the relevant document.

21. The method as claimed in claim 20, wherein said statistical information comprises any one or more of: document word count, document creation time and date, number of pages in or line breaks in the document, and document check sum-type information that reflects the digital contents of the document.

22. A method of using an electronic seal, the method including:
generating at a server an electronic seal for use in connection with an electronic communication or document to be sent by an agent to a recipient, said electronic seal including a reference to an object stored on said server,
permitting said agent to send said electronic seal to said recipient in connection with said electronic communication or document; and
recording details relating to the access of said object referred to by said electronic seal.

23. The method as claimed in claim 22, wherein said object is a graphical object that is displayed within the electronic communication generated by the agent.

24. The method as claimed in claim 23, further comprising the step of: recording the access requests generated in connection with each seal in a log.

25. The method as claimed in claim 24, wherein the log records the time of access and the network address from which that request originates.

26. The method as claimed in claim 25, further comprising the step of: modifying the details of the graphical object, based on the log, to indicate whether said electronic communication has been accessed.

27. A computer system for permitting a recipient of an electronic communication or document to assess the origin or other details of that communication or document, the computer system comprising:
means for maintaining a plurality of records of information relating to a plurality of respective agents;
means for allowing an agent to generate an electronic seal for use in connection with an electronic communication or document to be sent by said agent to a recipient; and
means for displaying or providing, to said recipient, seal information associated with said electronic seal;
wherein said seal information includes said agent information, and can be used by said recipient to assess the legitimacy of said electronic communication or document in connection with which said electronic seal is used.

28. Computer software for permitting a recipient of an electronic communication or document to assess the origin or other details of that communication or document, the computer software being installed on a medium and able to be executed by a computer system capable of interpreting the computer software, the computer software comprising:
software code means for maintaining a plurality of records of information relating to a plurality of respective agents;
software code means for allowing an agent to generate an electronic seal for use in connection with an electronic communication or document to be sent by said agent to a recipient; and
software code means for displaying or providing, to said recipient, seal information associated with said electronic seal;
wherein said seal information includes said agent information, and can be used by said recipient to assess the legitimacy of said electronic communication or document in connection with which said electronic seal is used.

29. A computer system for generating an electronic seal for use in connection with an electronic communication or document, the computer system comprising:
means for receiving from an agent a request to generate an electronic seal for use in connection with an electronic communication or document;
means for receiving from said agent a description of said electronic communication or document in connection with which said electronic seal is to be used; and
means for generating said electronic seal and providing said electronic seal to said agent for use in connection with said electronic communication or document;
wherein said electronic seal can be used in connection with said electronic communication or document provided by said agent to a recipient to allow said recipient to access seal information associated with said electronic seal.

30. Computer software for generating an electronic seal for use in connection with an electronic communication or document, the computer software being installed on a medium and able to be executed by a computer system able to interpret the computer software, the computer software comprising:
software code means for receiving from an agent a request to generate an electronic seal for use in connection with an electronic communication or document;
software code means for receiving from said agent a description of said electronic communication or document in connection with which said electronic seal is to be used; and
software code means for generating said electronic seal and providing said electronic seal to said agent for use in connection with said electronic communication or document;
wherein said electronic seal can be used in connection with said electronic communication or document provided by said agent to a recipient to allow said recipient to access seal information associated with said electronic seal.

31. A computer system for generating an electronic seal for use in connection with an electronic communication or document, the computer system comprising:
means for receiving from an agent an electronic document and a request to generate an electronic seal for use in connection with said document;
means for analyzing said electronic document to derive document information from said document in connection with which said electronic seal is to be used; and
means for generating said electronic seal and providing said electronic seal to said agent for use in connection with said electronic document; and
means for displaying or providing, to said recipient, seal information associated with said electronic seal;
wherein said seal information includes said document information, and can be used by said recipient to assess the legitimacy of said electronic document in connection with which said electronic seal is used.

32. Computer software for generating electronic seal for use in connection with an electronic communication or document, the computer software being installed on a medium and able to be executed by a computer capable of interpreting the computer software, the computer software comprising:
software code means for receiving from an agent an electronic document and a request to generate an electronic seal for use in connection with said document;
software code means for analyzing said electronic document to derive document information from said document in connection with which said electronic seal is to be used; and
software code means for generating said electronic seal and providing said electronic seal to said agent for use in connection with said electronic document; and
software code means for displaying or providing, to said recipient, seal information associated with said electronic seal;
wherein said seal information includes said document information, and can be used by said recipient to assess the legitimacy of said electronic document in connection with which said electronic seal is used.

33. A computer system for using an electronic seal, the computer system comprising:
means for generating at a server an electronic seal for use in connection with an electronic communication or document to be sent by an agent to a recipient, said electronic seal including a reference to an object stored on said server;
means for permitting said agent to send said electronic seal to said recipient in connection with said electronic communication or document; and
means for recording details relating to the access of said object referred to by said electronic seal.

34. Computer software for using an electronic seal, the computer software being installed on a medium and being able to be executed by a computer system capable of interpreting the computer software, the computer software comprising:
software code means for generating at a server an electronic seal for use in connection with an electronic communication or document to be sent by an agent to a recipient, said electronic seal including a reference to an object stored on said server;
software code means for permitting said agent to send said electronic seal to said recipient in connection with said electronic communication or document; and
software code means for recording details relating to the access of said object referred to by said electronic seal.

35. A method of providing contact information relating to agents, the method comprising the steps of:
maintaining a plurality of records of information relating to respective agents;
receiving a request from a subscriber to subscribe to agent information for one or said respective agents;
supplying, to said subscriber, agent information relating to said agent for which subscription is requested; and
notifying said subscriber of changes in said agent information.

36. A method for providing contact information relating to agents, the method comprising the steps of:
maintaining a plurality of records of information relating to respective agents; and
receiving a request to subscribe to agent information for an agent using an alphanumeric identifier unique to each of said plurality of records and unrelated to said contact information; and
supplying contact information relating to said agent for which subscription is requested;
wherein said alphanumeric identifier is received directly or indirectly from, or in connection to; said agent.

37. Computer software for managing contact information, the computer software being recorded on a medium and able to be executed by a computer system capable of interpreting the computer software, the computer software comprising:
means for communicating with a server storing a plurality of records of information relating to a plurality of respective agents; and
means for communicating with one or more information management applications used on, or able to be accessed via, a client computing device; and
means for receiving, from a subscriber, a request to subscribe to agent information;
wherein the server can be accessed to obtain agent information for use with said one or more contact information management applications.

38. The method as claimed in claim 36, further comprising the step of: notifying subscribers who subscribe to agent information when that agent information changes.

39. The method as claimed in claim 36, further comprising: changing the agent information in said one or more information management applications.

40. The method as claimed in claim 36, wherein the subscriber is able to interact with the client application to determine how the client application is to respond to updated agent information.

41. The method as claimed in claim 36, wherein the information management applications comprise email client applications having contact management features.

42. The method as claimed in claim 36, wherein subscribers are advised that agent information is updated with the assistance of a client application.

43. The method as claimed in claim 36, wherein agent information to which a subscriber subscribes can be entirely maintained on an application server, and accessed by the subscriber as required.

44. The method as claimed in claim 42, wherein said agent information is accessed by the subscriber using a network and a computing device able to acess the network.

45. A method for supplying business cards for agents of an organisation, the method comprising the steps of:
receiving design specifications for business cards to be printed for agents of said organisation;
receiving from said agents of said organisation respective agent information for said agents; and
printing business cards for said agents of said organisation in accordance with the design specifications and agent information approved by said organisation;
wherein said business cards can additionally include an indication that agent information provided on said business cards is able to be accessed in electronic form from an entity other than the organisation or the agent.

46. The method as claimed in claim 45, further comprising the step of: storing, by the third party entity of information for agents of various organisations.

47. The method as claimed in claim 46, wherein said third party entity is indicated as a source of the agent information by the additional indication included on the business cards.

48. The method as claimed in claim 47, wherein said indication is a visual indication.

49. The method as claimed in claim 48, wherein the visual indication is accompanied by an identifier such as an alphanumeric or graphic identifier, which is specific to the agent on whose business cards the identifier is published.

50. The method as claimed in claim 49, wherein the identifier is a machine readable identifier.

51. The method as claimed in claim 50, wherein the machine-readable identifier is a bar code.

52. The method as claimed in claim 50, wherein the identifier represents a unique serial number that facilitates electronic access to the contact details provided on the business cards.

53. The method as claimed in claim 50, wherein the identifier represents that the agent's contact details are available in electronic form via the third party entity.

54. Business cards supplied as claimed in claim 45.

55. Business cards for agents of an organisation, the business cards comprising printed information indicating the identity of the organisation, details for the agent and a visual marker that indicates that the agent information is available in electronic form from an entity other than the organisation or the agent.

56. A method of supplying business cards for agents of an organisation, the method comprising the steps of:
receiving design specifications for business cards to be printed for agents of said organisation;
receiving from said agents of said organisation respective agent information for said agents;
providing to said agents a draft business card generated in accordance with said design specifications and said respective agent information;
receiving approval from said organisation of said respective agent information submitted by said agents; and
printing business cards for said agents of said organisation in accordance with said design specifications and said agent information approved by said organisation.

57. The method as claimed in claim 56, wherein the business cards are provided for said agents when ordered by said organisation.

58. The method as claimed In claim 56, further comprising the step of: adding unordered business cards to an inventory of unordered business cards to be ordered, once said respective agent information is approved by the organisation.

59. A method of providing contact information relating to agents, the method comprising the steps of:
receiving a plurality of orders from respective agents for business cards for the respective agents;
receiving agent information associated with said plurality of orders;
providing business cards to said agents in response to said orders;
maintaining records of said agent information for each agent from which an order is received; and
providing said agent information for use by said agents and subscribers to said agent information.
